(19) United States
(12) Patent Application Publication
(10) Pub. No.: US 2018/0080586 A1
(43) Pub. Date: Mar. 22, 2018

(54) MULTILAYER HOLLOW BODY HAVING HIGH LEACHING RESISTANCE

(71) Applicant: Evonik Degussa GmbH, Essen (DE)

(72) Inventors: Jasmin BERGER, Dortmund (DE); Karl KUHMANN, Duelmen (DE); Mario RESING, Stadtlohn (DE); Jan HEIMINK, Schwelm (DE); Olivier FARGES, Marl (DE); Stefan ALTKEMPER, Dorsten (DE)

(73) Assignee: Evonik Degussa GmbH, Essen (DE)

(21) Appl. No.: 15/709,092

(22) Filed: Sep. 19, 2017

(30) Foreign Application Priority Data
Sep. 21, 2016 (EP) 16189917.4

(51) Int. Cl. F16L 11/12; F02M 37/00; B29C 47/00; B29C 47/06; B32B 27/34

(52) U.S. Cl. CPC F16L 11/125; F02M 37/0017; B29L 2022/00; B29C 47/06; B32B 27/34; B29C 47/0054

(57) ABSTRACT

A multilayer hollow body has the following layers: I. an inner layer (layer I) containing a moulding composition based on PA612, PA610, PA1010, PA1012 and/or PA1212 and copolymers thereof and mixtures thereof; II. optionally an adhesion promoter layer (layer II) containing a moulding composition based on the following components: a) 0 to 80 parts by weight of a polyamide selected from PA6, PA66, PA6/66 and mixtures thereof, b) 0 to 100 parts by weight of a polyamine-polyamide copolymer and c) 0 to 80 parts by weight of a polyamide selected from PA11, PA12, PA612, PA1010, PA1012, PA1212 and mixtures thereof, where the sum total of the parts by weight of components a), b) and c) is 100; III. a layer (layer III) containing an ethylene-vinyl alcohol copolymer moulding composition is executed in such a way that not more than 0.2 g/m2 of insoluble extract and not more than 7.0 g/m2 of soluble extract are washed out of the multilayer hollow body as an overall system on first exposure to fuel, determined on a multilayer pipe having the same layer structure, a wall thickness of 1 mm and an internal diameter of 6 mm.

### BACKGROUND OF THE INVENTION

### Field of the Invention

The invention provides a multilayer hollow body having very high leaching resistance via the selection of the moulding compositions used in the individual layers. The multilayer hollow body is primarily a hollow profile, for example a pipe, or a vessel for conduction or storage of liquid or gaseous media.

### Description of the Related Art

Flexible pipes which are used for routing of liquid or gaseous media in motor vehicles are well known. This problem was formerly solved satisfactorily by means of monolayer pipes made of polyamide or other thermoplastic moulding compositions. In the case of these monolayer pipes, it was found that the mechanical properties that exist after installation, such as high elongation at break and high impact resistance, even over the lifetime of the motor vehicle, are not so significantly altered by the effects of cold or heat or by contact with media as to result in failure of the conduit.

Stricter environmental regulations have led to a move away from the further development and use of monolayer pipes for use as a fuel line and from single-layer fuel vessels. In both cases, the automobile industry requires not only adequate fuel resistance but also an improved barrier effect with respect to the fuel components, in order to reduce the emissions thereof in the environment. This has led to the development of multilayer hollow bodies in which, for example, ethylene-vinyl alcohol copolymer (EVOH) is used as barrier layer material. Multilayer composites of this kind, which comprise not only an EVOH layer but also further layers based on aliphatic polyamides, are known, for example, from EP 1216826 A2.

Because of their good mechanical properties, their low water absorption capacity and their insensitivity toward environmental influences, polyamides are a useful material both for the inner layer and for the outer layer. However, EVOH is incompatible with polyamides such as PA11, PA12, PA1012 or PA1212 and has only low compatibility with PA612. However, adhesion between the adjoining layers is indispensable and can thus be ensured only with an intervening adhesion promoter layer. In the automobile industry, there has additionally for some time been a trend toward higher temperatures in the engine compartment and hence a demand for stability of the hollow bodies used at these temperatures. Solutions including an adhesion promoter layer based, for example, on polyolefins are thus unsuitable because of their low heat distortion resistance. EP 1216 826 A2 solves this problem through use of an adhesion-promoting layer comprising a polyamide selected from PA6, PA66 and PA6/66, optionally a polyamine-polyamide copolymer, and a polyamide selected from PA11, PA12, PA612, PA1012 and PA1212.

The advancing trend of “downsizing”, i.e. the reduction of component sizes while maintaining the same performance with the aim of lowering energy consumption of motor vehicle engines, for example, is leading not only to an increase in the temperatures that prevail in the engine compartment but also to a reduction in the size of the injection valves. These valves are nozzles which inject fuel into the intake tract or the combustion chamber of an internal combustion engine. Polar constituents present in fuels require that the multilayer pipe used be resistant to extraction of constituents from the materials used. U.S. Pat. No. 6,467,508 describes the precipitation of such extracts in the fuel and the possible blockage of the injection valves as a problem. This problem is solved by the use of a “low precipitate polyamide” in the inner layer. The “low precipitate polyamide” is washed polyamide which is obtained by inconvenient and costly preceding extraction with methanol. In this way, troublesome constituents, for example oligomers, are removed.

Following the progressive decrease in size of the injection nozzles, the automobile industry is also requiring not only the reduction of the extracts that precipitate out in the fuel, but also a reduction in the extracts that are soluble in the fuel. Because of the introduction of hybrid vehicles, this demand has been enhanced, since the internal combustion engine in these vehicles is not used for prolonged periods. Soluble extracts in the fuel can thus also lead, via drying-out, to blockage of injection nozzles. The problematic extracts originate not only from the inner layer of the multilayer pipe, but particularly also from all other layers that are not separated from the fuel by means of a barrier layer (such as an EVOH layer). Extracts are not only the oligomers described in U.S. Pat. No. 6,467,508, but also additives, for example plasticizers and stabilizers of the moulding compositions used.

### SUMMARY OF THE INVENTION

Accordingly, the problem addressed by the invention is that of providing a composite composed of an EVOH layer and at least one polyamide layer, which has high heat distortion resistance and high impact resistance, and in the case of which, in addition, good layer adhesion is obtained, with the entire multilayer composite having high leaching resistance, meaning that both insoluble and soluble extracts are at a very low level after contact with fuel.

The present invention relates to a multilayer hollow body, comprising the following layers:
I. an inner layer (layer I) comprising a moulding composition based on PA11, PA12, PA612, PA610, PA1010, PA1012 and/or PA1212 and copolymers thereof and mixtures thereof;
II. optionally an adhesion promoter layer (layer II) comprising a moulding composition based on the following components:
   a) 0 to 80 parts by weight of a polyamide selected from PA6, PA66, PA6/66 and mixtures thereof,
   b) 0 to 100 parts by weight of a polyamine-polyamide copolymer, and
   c) 0 to 80 parts by weight of a polyamide selected from PA11, PA12, PA612, PA1010, PA1012, PA1212 and mixtures thereof,

wherein the sum total of the parts by weight of components a), b) and c) is 100, and wherein, in addition, in the sum total of components a) and b), at least 16 parts by weight consist of monomer units which derive from caprolactam and/or the combination of hexamethylenediamine/adipic acid and, in the sum total of components b) and c), at least 20 parts by weight consist of monomer units which derive from ω-aminoundecanoic acid, laurolactam, the combination of hexamethylenediamine/dodecane-1,12-dioic acid, the combination of decane-1,10-diamine/decane-1,10-dioic acid, the combination of decane-1,10-diamine/dodecane-1,12-dioic acid and/or the combination of dodecane-1,12-diamine/dodecane-1,12-dioic acid;
III. a layer (layer III) comprising an ethylene-vinyl alcohol copolymer moulding composition,

wherein the moulding composition of layer I and optionally the moulding composition of layer II does not comprise any plasticizer and wherein furthermore not more than 0.2 g/m² of insoluble extract and not more than 7.0 g/m² of soluble extract are washed out of the multilayer hollow body as an overall system on first exposure to fuel, determined by the method described in the Experimental on a multilayer pipe having the same layer structure, a wall thickness of 1 mm and an internal diameter of 6 mm.

### DETAILED DESCRIPTION OF THE INVENTION

The above-mentioned problem is solved by a multilayer hollow body according to the invention comprising the following layers:
I. an inner layer (layer I) composed of a moulding composition based on PA612, PA610, PA1010, PA1012 and/or PA1212 and copolymers thereof and mixtures thereof;
II. optionally an adhesion promoter layer (layer II) composed of a moulding composition based on the following components:
   a) 0 to 80 parts by weight of a polyamide selected from PA6, PA66, PA6/66 and mixtures thereof,
   b) 0 to 100 parts by weight of a polyamine-polyamide copolymer and
   c) 0 to 80 parts by weight of a polyamide selected from PA11, PA12, PA612, PA1010, PA1012, PA1212 and mixtures thereof,
      where the sum total of the parts by weight of components a), b) and c) is 100, and where, in addition, in the sum total of components a) and b), at least 16 parts by weight consist of monomer units which derive from caprolactam and/or the combination of hexamethylenediamine/adipic acid and, in the sum total of components b) and c), at least 20 parts by weight consist of monomer units which derive from ω-aminoundecanoic acid, laurolactam, the combination of hexamethylenediamine/dodecane-1,12-dioic acid, the combination of decane-1,10-diamine/decane-1,10-dioic acid, the combination of decane-1,10-diamine/dodecane-1,12-dioic acid and/or the combination of dodecane-1,12-diamine/dodecane-1,12-dioic acid;
III. a layer (layer III) composed of an ethylene-vinyl alcohol copolymer moulding composition,
   wherein not more than 0.2 g/m², preferably not more than 0.18 g/m² and more preferably not more than 0.16 g/m² of insoluble extract and not more than 7.0 g/m², preferably not more than 6.0 g/m² and more preferably not more than 5.5 g/m² of soluble extract are washed out of the multilayer hollow body as an overall system on first exposure to fuel, determined by the method described in the Experimental on a multilayer pipe having the same layer structure, a wall thickness of 1 mm and an internal diameter of 6 mm. If the multilayer hollow body has a different wall geometry, in order to provide comparability, it is thus necessary to convert the individual layer thicknesses to a total wall thickness of 1 mm.

The low extract content according to the claims is achieved via the selection of the polyamide and via the measure that the moulding composition of layer I and preferably also the moulding composition of layer II does not comprise any plasticizer. Furthermore, it is advantageous when the moulding composition of layer I and preferably also the moulding composition of layer II comprises just the necessary amount of stabilizers and processing auxiliaries.

The expression “based on” means here that the respective moulding composition contains at least 50% by weight, preferably at least 60% by weight, more preferably at least 65% by weight and especially preferably at least 70% by weight of these polyamides or of the polyamine-polyamide copolymer, based in each case on the overall moulding composition. In addition, further additives described in detail further down are generally present, so as to give rise to an overall sum total of 100% by weight. It is further preferable that the moulding composition does not comprise any further polyamides.

“The same layer structure” means that not only the layer sequence and composition of the layers are the same, but also that, in the event of different wall thickness, the individual layer thicknesses are converted to total wall thickness 1 mm.

The inner layer (layer I) is intended to be in direct contact with the medium conveyed or stored.

The multilayer hollow body is preferably a component of a fuel system, for example a fuel line or a fuel vessel, the fuel further preferably being gasoline.

The adhesion promoter layer (layer II) is optional particularly when the moulding composition of layer I contains PA610, and especially when the polyamide of layer I consists of PA610, since, in this case, adhesion between layer I and layer III sufficient for many applications can be achieved. When the layer I is based on one or more of the other polyamides according to the claims, layer II or an equivalent adhesion promoter layer is generally required.

In a preferred embodiment, the layer I consists of a moulding composition based on PA612, PA610, PA1010, PA1012 and/or PA1212 and copolymers thereof and mixtures thereof In this embodiment, it is further preferable that the moulding composition of layer II contains neither PA11 nor PA12.

The polyamide of layer I is more preferably PA612. In this case, it is further preferable that the moulding composition of layer II contains a mixture of PA612 and PA6 as polyamide component.

The amount of component a) present in the moulding composition of layer II is preferably at least 0.5 part by weight, more preferably at least 10 parts by weight, especially preferably at least 20 parts by weight and most preferably at least 30 parts by weight, whereas the upper limit is preferably 70 parts by weight and more preferably 60 parts by weight.

The amount of component b) present in the moulding composition of layer II is preferably at least 0.5 part by weight, more preferably at least 2 parts by weight, especially preferably at least 5 parts by weight and most preferably at least 10 parts by weight, whereas the upper limit is preferably 80 parts by weight, more preferably 60 parts by weight and especially preferably 40 parts by weight.

The amount of component c) present in the moulding composition of layer II is preferably at least 0.5 part by weight, more preferably at least 10 parts by weight, especially preferably at least 20 parts by weight and most preferably at least 30 parts by weight, whereas the upper limit is preferably 70 parts by weight and more preferably 60 parts by weight.

In a preferred embodiment, layers I, II and III follow in direct succession.

In a further preferred embodiment, layer III is followed on the outside by further layers preferably consisting of polyamide moulding compositions. It is particularly preferable here that there is an adjoining layer IV on the outside, containing the same polyamide combination as a layer II. Most preferably, this is followed by a layer V composed of a polyamide moulding composition based on PA11, PA12 or the same polyamides as a layer I.; in this way, the mechanical properties required for the use are assured and, at the same time, the layer III is effectively protected from the ingress of air humidity, which would reduce the barrier effect.

In the context of the invention, when advisable for the purposes of the application, a further layer of a polyamide moulding composition based on a polyamide having good adhesion to EVOH may additionally be present between the layer II and the layer III and/or between the layer III and the layer IV. This polyamide is, for example, PA6, PA66 or PA6/66.

The layer II in the simplest case is a blend of components a) and c). Since these polymers are largely incompatible with one another, in blend production at customary processing temperatures, which leads to a physical mixture, a sufficient adhesion promoter effect is only achieved within a relatively narrow range of composition. Better results are obtained when the polyamide blend is produced under conditions under which there is a certain degree of reaction of the two polyamides with one another via the end groups or via transamidation reactions to give block copolymers. For this purpose, temperatures above 250° C., preferably above 280° C. and more preferably above 300° C. and, if appropriate, the presence of catalysts such as hypophosphorous acid, dibutyltin oxide, triphenylphosphine or phosphoric acid are generally required. It is also possible to proceed from a polyamide blend initially prepared under customary processing conditions, which is then subjected to solid phase postcondensation under conditions customary for polyamides. These are generally temperatures above 140° C. to about 5 K below the crystalline melting point Tₘ, preferably temperatures above 150° C. to about 10 K below Tₘ, with reaction times of 2 to 48 hours, preferably 4 to 36 hours and more preferably 6 to 24 hours. Particularly advantageously, one polyamide contains an excess of amino end groups and the other polyamide an excess of carboxyl end groups. Finally, linkage of components a) and c) can also be achieved by addition of a reactive compound which preferably joins the polyamide end groups to one another, for example a bisoxazoline, biscarbodiimide, bisanhydride, diisocyanate or the corresponding compounds having three or more functional groups.

Another way of making components a) and c) compatible with one another is the addition of an effective amount of component b).

The individual components are elucidated in detail hereinafter.

PA6 is prepared by ring-opening polymerization of caprolactam.

PA66 is prepared by polycondensation of hexamethylenediamine and adipic acid. Just like PA6, it is commercially available in a multitude of types.

PA6/66 is a copolycondensate proceeding from the monomers caprolactam, hexamethylenediamine and adipic acid.

The polyamine-polyamide copolymer is prepared using the following monomers:
a) 0.5% to 25% by weight, preferably 1% to 20% by weight and more preferably 1.5% to 16% by weight, based on the polyamine-polyamide copolymer, of a polyamine having at least 4, preferably at least 8 and more preferably at least 11 nitrogen atoms and a number-average molecular weight Mₙ of at least 146 g/mol, preferably of at least 500 g/mol and more preferably of at least 800 g/mol, and also
b) polyamide-forming monomers selected from lactams, ω-aminocarboxylic acids and/or equimolar combinations of diamine and dicarboxylic acid.

In a preferred embodiment, the amino group concentration of the polyamine-polyamide copolymer is in the range from 100 to 2500 mmol/kg.

Examples of polyamines that can be used include the following substance classes:
polyvinylamines (Römpp Chemie Lexikon [Römpp's Chemical Dictionary], 9th Edition, Volume 6, page 4921, Georg Thieme Verlag Stuttgart 1992);
polyamines that are prepared from alternating polyketones (DE-A 196 54 058);
dendrimers, for example
   ((H₂N—(CH₂)₃)₂N—(CH₂)₃)₂—N(CH₂)₂—N((CH₂)₂—N((CH₂)₃—NH₂)₂)₂ (DE-A-196 54 179) or
   tris(2-aminoethyl)amine, N,N-bis(2-aminoethyl)-N′,N′-bis[2-[bis(2-aminoethyl)amino]ethyl]-1,2-ethanediamine,
   3,15-bis(2-aminoethyl)-6,12-bis[2-[bis(2-aminoethyl)amino]ethyl]-9-[bis[2-bis(2-aminoethyl)amino]ethyl]amino]ethyl]-3,6,9,12,15-pentaazaheptadecane-1,17-diamine (J. M. Warakomski, Chem. Mat. 1992, 4, 1000-1004);
linear polyethyleneimines which can be prepared by polymerization of 4,5-dihydro-1,3-oxazoles followed by hydrolysis (Houben-Weyl, Methoden der Organischen Chemie [Methods of Organic Chemistry], Vol. E20, pp. 1482-1487, Georg Thieme Verlag Stuttgart, 1987);
branched polyethyleneimines obtainable by polymerization of aziridines (Houben-Weyl, Methoden der Organischen Chemie, Vol. E20, pp. 1482-1487, Georg Thieme Verlag Stuttgart, 1987) and generally having the following amino group distribution:
   25% to 46% of primary amino groups,
   30% to 45% of secondary amino groups, and
   16% to 40% of tertiary amino groups.

In the preferred case the number-average molar mass Mₙ of the polyamine is at most 20 000 g/mol, more preferably at most 10 000 g/mol and especially preferably at most 5000 g/mol.

Lactams and ω-aminocarboxylic acids which are used as polyamide-forming monomers comprise from 4 to 19 carbon atoms, in particular from 6 to 12. Particular preference is given to use of caprolactam, ε-aminocaproic acid, caprylolactam, ω-aminocaprylic acid, laurolactam, ω-aminododecanoic acid and/or ω-aminoundecanoic acid.

Examples of combinations of diamine and dicarboxylic acid are hexamethylenediamine/adipic acid, hexamethylenediamine/dodecanedioic acid, octamethylenediamine/sebacic acid, decamethylenediamine/sebacic acid, decamethylenediamine/dodecanedioic acid, dodecamethylenediamine/dodecanedioic acid and dodecamethylenediamine/2,6-naphthalenedicarboxylic acid. However, it is possible to use not only these but also any other combination, for example decamethylenediamine/dodecanedioic acid/terephthalic acid, hexamethylenediamine/adipic acid/terephthalic acid, hexamethylenediamine/adipic acid/caprolactam, decamethylenediamine/dodecanedioic acid/ω-aminoundecanoic acid, decamethylenediamine/dodecanedioic acid/laurolactam, decamethylenediamine/terephthalic acid/laurolactam or dodecamethylenediamine/2,6-naphthalenedicarboxylic acid/laurolactam.

In the case of the polyamine-polyamide copolymer, the composition of the polyamide component may vary within a very wide range, since compatibility with the polyamides of components a) and c) is apparently determined by other factors and generally exists.

The polyamine-polyamide copolymers can be prepared by various methods.

One means is to initially charge the polyamide-forming monomers and the polyamine together and to conduct the polymerization or polycondensation. However, a preferred process involves first, if appropriate, conducting the lactam cleavage and the prepolymerization in the presence of water in a two-stage process (alternatively, the corresponding ω-aminocarboxylic acids or diamines and dicarboxylic acids are used and prepolymerized directly); the polyamine is added in the second step. Then the system is decompressed at temperatures between 200 and 290° C. and polycondensation is effected in a nitrogen stream or under reduced pressure.

A further preferred process involves the hydrolytic degradation of a prepolyamide to give a pre-polymer and simultaneous or subsequent reaction with the polyamine. Preference is given to using polyamides in which the end group differential is approximately zero.

By these methods, it is possible to prepare ultra-highly branched polyamides having acid numbers less than 40 mmol/kg, preferably less than 20 mmol/kg and more preferably less than 10 mmol/kg. Even after a reaction time of 1 to 5 hours at temperatures of 200° C. to 290° C., a virtually full conversion is achieved.

If the intention is not to conduct the reaction to completion in the melt, the polyamine-polyamide copolymers, according to the related art, can also be postcondensed in the solid phase.

PA11 is prepared by polycondensation of ω-aminoundecanoic acid, while PA12 is obtained by ring-opening polymerization of laurolactam. Both polymers are commercially available in a multitude of grades.

PA610 is prepared in a known manner by polycondensation of an equivalent mixture of hexamethylenediamine and decane-1,10-dioic acid, while PA612 is prepared in a known manner by polycondensation of an equivalent mixture of hexamethylenediamine and dodecane-1,12-dioic acid, and PA1010 in a likewise known manner by polycondensation of an equivalent mixture of decane-1,10-diamine and decane-1,10-dioic acid.

PA1012 is prepared by polycondensation of an equivalent mixture of decane-1,10-diamine and dodecane-1,12-dioic acid, while PA1212 is obtained in the same way from dodecane-1,12-diamine and dodecane-1,12-dioic acid.

Advantageously, it is also possible here to use mixtures of different polyamides, e.g. PA12/PA1012 or PA12/PA1212. Mixtures of this kind feature particularly high low-temperature impact resistance; they are described, for example, in EP-A-0 388 583.

The polyamide moulding compositions of layers I, II, IV and V that are used in accordance with the invention optionally contain further additives as well as the polymer components described. These further additives, taking account of the restrictions mentioned further down, are, for example:
a) stabilizers,
b) other polymers,
c) impact modifiers,
d) plasticizers,
e) pigments and/or dyes,
f) additives which increase electrical conductivity and
g) processing auxiliaries.

In a preferred embodiment, the moulding compositions comprise an effective amount of an oxidation stabilizer and more preferably an effective amount of an oxidation stabilizer in combination with the effective amount of a copper-containing stabilizer. Examples of suitable oxidation stabilizers include aromatic amines, sterically hindered phenols, phosphites, phosphonites, thiosynergists, hydroxylamines, benzofuranone derivatives, acryloyl-modified phenols etc. A great many types of such oxidation stabilizers are commercially available, for example under the trade names Naugard 445, Irganox 1010, Irganox 1098, Irgafos 168, P-EPQ or Lowinox DSTDP. In general, the moulding compositions contain about 0.01% to about 2% by weight and preferably about 0.1% to about 1.5% by weight of an oxidation stabilizer.

In addition, the moulding compositions may also comprise a UV stabilizer or a light stabilizer of the HALS type. Suitable UV stabilizers are primarily organic UV absorbers, for example benzophenone derivatives, benzotriazole derivatives, oxalanilides or phenyltriazines. Light stabilizers of the HALS type are tetramethylpiperidine derivatives; these are inhibitors which act as radical scavengers. UV stabilizers and light stabilizers may advantageously be used in combination. A great many types of both are commercially available; the manufacturer's instructions can be followed in respect of the dosage.

The moulding compositions may additionally comprise a hydrolysis stabilizer, for instance a monomeric, oligomeric or polymeric carbodiimide or a bisoxazoline.

Examples of other polymers which may be present in the moulding compositions as additive include polyetheramides, or polytetrafluoroethylene (PTFE).

Impact-modifying rubbers for polyamide moulding compositions form part of the related art. They contain functional groups which originate from unsaturated functional compounds that are either included in the main chain polymer or grafted onto the main chain. The most commonly used are EPM or EPDM rubber which has been free-radically grafted with maleic anhydride. Rubbers of this kind can also be used together with an unfunctionalized polyolefin, for example isotactic polypropylene, as described in EP-A-0 683 210.

Plasticizers and the use thereof in polyamides are known. A general overview of plasticizers suitable for polyamides can be found in Gächter/Müller, Kunststoffadditive [Plastics additives], C. Hanser Verlag, 2nd Edition, p. 296.

Examples of conventional compounds suitable for employment as plasticizers include esters of p-hydroxybenzoic acid having 2 to 20 carbon atoms in the alcohol component or amides of arylsulphonic acids having from 2 to 12 carbon atoms in the amine component, preferably amides of benzenesulphonic acid.

Useful plasticizers include ethyl p-hydroxybenzoate, octyl p-hydroxybenzoate, i-hexadecyl p-hydroxybenzoate, N-n-octyltoluenesulphonamide, N-n-butylbenzenesulphonamide or N-2-ethylhexylbenzenesulphonamide.

Examples of suitable pigments and/or dyes include carbon black, iron oxide, zinc sulphide, ultramarine, nigrosin, pearlescent pigments and metal flakes.

Examples of additives which increase electrical conductivity include conductive black or carbon nanotubes.

Examples of suitable processing aids include paraffins, fatty alcohols, fatty acid amides, stearates such as calcium stearate, paraffin waxes, montanates or polysiloxanes.

The moulding compositions produced from the individual constituents in a manner known to those skilled in the art by melt mixing.

The EVOH of layer III is a copolymer of ethylene and vinyl alcohol. The ethylene content in the copolymer is generally 25 to 60 mol % and especially 28 to 45 mol %. A multitude of grades are commercially available. Reference is made by way of example to the company brochure “Introduction to Kuraray EVAL™ Resins”, Version 1.2/9810 from Kuraray EVAL Europe. The moulding composition may, in addition to the EVOH according to the related art, contain further additives as customary for barrier layer applications. Additives of this kind are generally part of the know-how of the EVOH supplier.

When the multilayer composite according to the invention is used for routing or storage of combustible liquids, gases or dusts, for example fuel or fuel vapours, it is advisable to render one of the layers that forms part of the composite electrically conductive. This can be achieved by compounding with an electrically conductive additive by any related art method. Examples of conductive additives that can be used include conductive black, metal flakes, metal powder, metallized glass beads, metallized glass fibres, metal fibres (for example of stainless steel), metallized whiskers, carbon fibres (including metallized carbon fibres), intrinsically conductive polymers or graphite fibrils. It is also possible to use mixtures of different conductive additives.

In the preferred case, the electrically conductive layer is in direct contact with the medium to be routed or stored and has a specific surface resistivity of not more than 10⁹ Ω/square and preferably not more than 10⁶ Ω/square. The measurement method for determining the resistance of multilayer pipes is elucidated in SAE J 2260 of November 2004. In this case, either layer I as a whole has been rendered electrically conductive or layer I consists of two sublayers, one of which has been rendered electrically conductive and the other electrically nonconductive.

When the multilayer composite according to the invention is executed as a hollow profile (for example a pipe) or vessel, said composite may be sheathed with an additional elastomer layer. Both crosslinking rubber compositions and thermoplastic elastomers are suitable for the sheathing. The sheathing may be applied to the multilayer composite either with or without the use of an additional adhesion promoter, for example by coextrusion, extrusion through a crosshead die or by sliding a prefabricated elastomer hose over the ready-extruded multilayer pipe. The sheathing generally has a thickness of 0.1 to 4 mm and preferably of 0.2 to 3 mm.

Examples of suitable elastomers include chloroprene rubber, ethylene-propylene rubber (EPM), ethylene-propylene-diene rubber (EPDM), epichlorohydrin rubber (ECO), chlorinated polyethylene, acrylate rubber, chlorosulphonated polyethylene, silicone rubber, plasticized PVC, polyetheresteramides or polyetheramides.

The multilayer composite may be fabricated in one or more stages, for example by a single-stage process by means of sandwich moulding, coextrusion, coextrusion blow moulding (for example including 3D blow moulding, extrusion of a parison into an open half-mould, 3D parison manipulation, suction blow moulding, 3D suction blow moulding, sequential blow moulding) or by multistage processes as described in U.S. Pat. No. 5,554,425 for example.

The invention is to be elucidated by way of example in the Experimental which follows.

In the examples, the following components/moulding compositions were used:

VESTAMID LX9002: A plasticized and impact-modified extrusion moulding composition based on PA12 from EVONIK Resource Efficiency GmbH

VESTAMID SX8002: A plasticized and impact-modified extrusion moulding composition based on PA612 and PA6 from EVONIK Resource Efficiency GmbH

VESTAMID SX8001: A plasticized and impact-modified extrusion moulding composition based on PA6 from EVONIK Resource Efficiency GmbH

EVAL F101: An EVOH from Kuraray with 32 mol % of ethylene

Having generally described this invention, a further understanding can be obtained by reference to certain specific examples which are provided herein for purposes of illustration only, and are not intended to be limiting unless otherwise specified.

### EXAMPLE 1

A five-layer pipe with an external diameter of 8 mm and a total wall thickness of 1 mm was produced by means of coextrusion with the following layer configuration:

Layer V: VESTAMID LX9002

Layer IV: VESTAMID SX8002

Layer III: EVAL F101

Layer II: impact-modified extrusion moulding composition based on PA612 and PA6 with the following composition:
65.3% by weight of PA612
17.5% by weight of PA6
16% by weight of polyolefinic impact modifier
1.2% by weight of stabilizer and
0.02% by weight of calcium stearate as processing auxiliary

Layer I: impact-modified extrusion moulding composition based on PA612 with the following composition:
89.5% by weight of PA612
10% by weight of polyolefinic impact modifier
0.5% by weight of stabilizer and
0.02% by weight of calcium stearate

Comparative Example 1 (according to EP 1216826 A2; in use in the automobile industry for fuel lines):

A four-layer pipe with an external diameter of 8 mm and a total wall thickness of 1 mm was produced by means of coextrusion with the following layer configuration:

Layer V: VESTAMID LX9002

Layer IV: VESTAMID SX8002

Layer III: EVAL F101

Layer I: VESTAMID SX8001

Tests:
a) Tensile test: The multilayer pipes were tested in accordance with DIN EN ISO 527-1 at a takeoff speed of 100 mm/min. The test specimens had a length of about 200 mm, the clamped length was 100 mm and strain sensor spacing was 50 mm.
b) Impact bending test: Measurement of impact resistance for the multilayer pipes was in accordance with DIN 73378 at 23° C. and −40° C. For this purpose, ten pipe sections of about 100 mm in length were used in each case.
c) Fall hammer test: The fall hammer test was carried out as per SAE specifications. This comprised allowing a specific weight to fall onto the test specimen from a prescribed fall height. This test was used to determine the impact resistance characteristics of the multilayer pipes under an impact according to SAE J2260 and SAE J844. In each case ten test specimens were measured at −40° C. and, once subjected to the test, visually inspected for damage.
d) Separation test: The separation test was carried out with a Zwick BZ 2.5/TN1S tensile tester to which a tensile device and a rotating metal wheel are attached to enable the individual layers of the test sample to be separated from one another. The separation test in accordance with DIN EN ISO 2411 was used to determine the adhesion between two layers by measuring the force required to separate the two layers from one another. To this end, pipe sections of the multilayer pipes 20 cm in length were divided longitudinally into three portions using a cutting device.

Prior to starting measurement, calipers were used to measure the sample width repeatedly at different points and the average value was entered into the evaluation software. The incipiently separated end of one layer was then held in a clamp which continuously pulled said layer from the second layer at an angle of 90°.

The layers were pulled apart at a test speed of 50 mm/min while, simultaneously, a diagram of the required force in newtons versus the displacement in millimetres was recorded. This diagram was used to determine the separation resistance in newtons per millimetre which relates to the width of the adherent contact area.
e) Fuel permeability: The permeation measurement was used to determine how much fuel per day and metre of pipe/square metre of the inner pipe area permeates through a fuel line in the case of static storage at 60° C. Pipe sections of length 300 mm were weighed, then filled with 300 ml of CE10 (composition according to ASTM D471: 45% by volume of toluene, 45% by volume of isooctane and 10% by volume of ethanol), and the ends were closed. The filled pipes were weighed once again, in order to be able to determine the loss of mass and hence the permeated mass of fuel at particular time intervals. The effective permeation length was 285 mm.
f) Leaching resistance: By means of the determination of leaching, it was ascertained how many g/m² of the inner pipe surface in the form of soluble and insoluble constituents are extracted from the multilayer composite after exposure to fuel. For this purpose, a pipe section of length 2 m was filled completely with the FAM B test fuel (according to DIN 51604-1/2) and closed, and stored at 60° C. for 96 h. After cooling, the pipe was emptied into a beaker and rinsed with 20 ml of FAM B. The liquid obtained was stored at 23° C. for 24 h. Thereafter, the test liquid was filtered under reduced pressure at 23° C. and rinsed through with 20 ml of FAM B. The filtered medium was left to evaporate in a fume hood at room temperature. This gave the soluble extracts by means of weighing. The filter was dried at 40° C. for 24 h and weighed. The difference from the original weight of the filter was used to determine the insoluble extracts.

The results are shown in Table 1.

TABLE 1
Layer configurations and test results

| | Comparative Example 1 | Example 1 |
|---|---|---|
| Layer V | VESTAMID LX9002; 0.3 mm | VESTAMID LX9002; 0.45 mm |
| Layer IV | VESTAMID SX8002, 0.1 mm | VESTAMID SX8002; 0.1 mm |
| Layer III | EVAL F101; 0.15 mm | EVAL F101; 0.15 mm |
| Layer II | — | 0.1 mm |
| Layer I | VESTAMID SX8001; 0.45 mm | 0.2 mm |
| Adhesion [N/mm] | Layer V to layer IV: 9.5 | Layer V to layer IV: 11.3 |
| | Layer IV to layer III: 8.3 | Layer IV to layer III: 9.6 |
| | Layer III to layer I: separation | Layer III to layer II: 8.7 |
| | impossible | Layer II to layer I: |
| | | separation impossible |
| Impact resistance 23° C. | no fracture | no fracture |
| −40° C. | no fracture | no fracture |
| Fall hammer test | | |
| SAE J844, −40° C. | no fracture | no fracture |
| SAE J2260, −40° C. | no fracture | no fracture |
| Fuel permeation [g/(m²*d)] | 1.5 | 1.9 |
| Leaching resistance, insoluble | 0.32 | 0.16 |
| extracts [g/m²] | | |
| Leaching resistance, soluble | 41.1 | 5.4 |
| extracts [g/m²] | | |

The pipe according to the invention therefore fulfils the demands that are made on fuel lines and has excellent leaching resistance compared to pipes used at present.

European patent application 16189917.4 filed Sep. 21, 2016, is incorporated herein by reference.

Numerous modifications and variations on the present invention are possible in light of the above teachings. It is therefore to be understood that within the scope of the appended claims, the invention may be practiced otherwise than as specifically described herein.

1. A multilayer hollow body, comprising the following layers:
I. an inner layer (layer I) comprising a moulding composition based on PA11, PA12, PA612, PA610, PA1010, PA1012 and/or PA1212 and copolymers thereof and mixtures thereof;
II. optionally an adhesion promoter layer (layer II) comprising a moulding composition based on the following components:
a) 0 to 80 parts by weight of a polyamide selected from PA6, PA66, PA6/66 and mixtures thereof,
b) 0 to 100 parts by weight of a polyamine-polyamide copolymer, and
c) 0 to 80 parts by weight of a polyamide selected from PA11, PA12, PA612, PA1010, PA1012, PA1212 and mixtures thereof,
wherein the sum total of the parts by weight of components a), b) and c) is 100, and wherein, in addition, in the sum total of components a) and b), at least 16 parts by weight consist of monomer units which derive from caprolactam and/or the combination of hexamethylenediamine/adipic acid and, in the sum total of components b) and c), at least 20 parts by weight consist of monomer units which derive from ω-aminoundecanoic acid, laurolactam, the combination of hexamethylenediamine/dodecane-1,12-dioic acid, the combination of decane-1,10-diamine/decane-1,10-dioic acid, the combination of decane-1,10-diamine/dodecane-1,12-dioic acid and/or the combination of dodecane-1,12-diamine/dodecane-1,12-dioic acid;
III. a layer (layer III) comprising an ethylene-vinyl alcohol copolymer moulding composition,
wherein the moulding composition of layer I and optionally the moulding composition of layer II does not comprise any plasticizer and wherein furthermore not more than 0.2 g/m² of insoluble extract and not more than 7.0 g/m² of soluble extract are washed out of the multilayer hollow body as an overall system on first exposure to fuel, determined by the method described in the Experimental on a multilayer pipe having the same layer structure, a wall thickness of 1 mm and an internal diameter of 6 mm.

2. The multilayer hollow body according to claim 1, wherein layer II is present.

3. The multilayer hollow body according to claim 2, wherein layers I, II and III follow in direct succession.

4. The multilayer hollow body according to claim 1, wherein the moulding composition of layer I comprises PA610 and layer II is absent.

5. The multilayer hollow body according to claim 4, wherein layers I and III follow in direct succession.

6. The multilayer hollow body according to claim 1, wherein the polyamide of the moulding composition of layer I is PA612.

7. The multilayer hollow body according to claim 1, which is adjoined on the outside by at least one further layer optionally consisting of a polyamide moulding composition.

8. The multilayer hollow body according to claim 7, wherein a further layer is a layer IV comprising the same polyamide combination as a layer II.

9. The multilayer hollow body according to claim 1, wherein one of the further layers is a layer V which follows a layer IV and is based on the same polyamides as a layer I.

10. The multilayer hollow body according to claim 1, which is a hollow profile, especially a pipe, or a vessel.

11. The multilayer hollow body according to claim 10, which comprises one or more further layers selected from an electrically conductive layer and an elastomer sheath.

12. The multilayer hollow body according to claim 1, which is a component of a fuel system.

13. The multilayer hollow body according to claim 12, which is a fuel line or a fuel vessel.
